(19) United States
(12) Patent Application Publication
(10) Pub. No.: US 2009/0038444 A1
(43) Pub. Date: Feb. 12, 2009

(54) Wrench

(76) Inventor: Bobby Hu, Taichung (TW)

Correspondence Address: KAMRATH & ASSOCIATES P.A., 4825 OLSON MEMORIAL HIGHWAY, SUITE 245, GOLDEN VALLEY, MN, 55422, US

(21) Appl. No.: 11/836,282

(22) Filed: Aug. 9, 2007

(51) Int. Cl. B25B 13/46

(52) U.S. Cl. 81/63.2

(57) ABSTRACT

A wrench includes a body having a shorter first section with a compartment and a longer second section. First and second plates are respectively mounted to two sides of the first section. A drive member is rotatably received in mounting holes in the plates and the compartment. The first plate is sandwiched between the first section and a flange on an end of the drive member. A retainer is coupled with a coupling portion on the other end of the drive member to rotatably retain the drive member in place and to secure the first and second plates and the body together. A pawl is slideably received in the compartment and includes a toothed section biased by an elastic element to engage with an annular toothed portion of the drive member. The first and second plates and the body have aligned fixing holes through which a fastener extends.

### BACKGROUND OF THE INVENTION

The present invention relates to a wrench and, more particularly, to a wrench having steel plates that require simpler mechanical processing to allow easy, rapid assembly at low costs.

Wrenches with handles formed by forging include a thinner handle and two thicker heads on two ends of the handle. These wrenches are popular with professional users for high-torque capacity provided by the thicker heads as well as gripping comfort provided by the thinner handle, and an example of which is disclosed in TW M281760. However, the costs of forging are high and stock may be a problem, for about 20,000 pieces of handles are produced per batch. Furthermore, subsequent processing is required after heat forging, leading to an increase in the period of time for production and in the costs. Meanwhile, wrenches for professional users have higher standards for processing and assembling. Thus, wrenches of this type are too expensive for DIY users.

To save costs, a handle including an upper body, a lower body, and an inner plate sandwiched between the upper and lower bodies is proposed. Each of the upper and lower bodies has the same thickness in the head portion and the gripping portion. The inner plate is made of rigid plastic material. The upper and lower bodies and the inner plate are fixed together by rivets. Such a handle is light to allow easy operation, and an example of which is disclosed in TW M296764. However, the head portion, if too thin, cannot withstand high torque such that damage occurs easily and that the wrench is liable to escape from the user's hand when a large torque is applied to the handle. On the other hand, if the head portion has a thickness sufficient to withstand large torque, the handle having the same thickness will be too thick to provide comfort gripping and to operate. U.S. Pat. Nos. 5,119,701; 5,603,247; 5,946,987; and 6,101,902 disclose similar structures having the same or similar disadvantages resulting from uniform thickness throughout the handle and the heads.

It is therefore a need in a wrench that can be produced at low costs while meeting needs of general users as well as professional users.

### BRIEF SUMMARY OF THE INVENTION

The present invention solves this need and other problems in the field of wrenches by providing, in a preferred form, a wrench including a body having a first section and a second section longer than the first section. The first section includes a first fixing hole and a compartment. The compartment and the fixing hole extend from one of two opposite sides through the other side of the first section. The second section is adapted to be gripped by a user. A first plate is mounted to one of the sides of the first section of the body. The first plate includes a second fixing hole aligned with the first fixing hole. The first plate further includes a first mounting hole aligned with the compartment. A second plate is mounted to the other side of the first section of the body. The second plate includes a third fixing hole aligned with the first and second fixing holes. The second plate further includes a second mounting hole aligned with the first mounting hole and the compartment. A drive member includes first and second ends and an annular toothed portion between the first and second ends. The annular toothed portion is rotatably received in the first and second mounting holes and the compartment. The first and second ends of the drive member respectively extend beyond the first and second plates. The first plate is sandwiched between a flange on the first end of the drive member and the first section of the body. A retainer is coupled with a coupling portion on the second end of the drive member to rotatably retain the drive member in place and to secure the first and second plates and the body together. A pawl is slideably received in the compartment and includes a toothed section biased by an elastic element to engage with the annular toothed portion of the drive member. A fastener extends through the first, second, and third fixing holes to secure the first and second plates and the body together The body and the first and second plates are preferably steel plates that can be formed by punching inexpensive steel blanks.

The fastener may be a bolt, and the third fixing hole of the second plate may be a screw hole threadedly engaged with an outer threading of the bolt. The costs of the wrench are, thus, cut. The first plate may have a thickness smaller than that of the second plate to further cut the costs. The first and second plates have identical length the same as that of the first section of the body. An overall length of the body is greater than two times of the length of the first section of the body. The drive member can be utilized to couple with a socket, a screwdriver bit, or a fastener such as a bolt, a nut, etc.

The present invention will become clearer in light of the following detailed description of illustrative embodiments of this invention described in connection with the drawings.

### DESCRIPTION OF THE DRAWINGS

The illustrative embodiments may best be described by reference to the accompanying drawings where:

FIG. 1 shows a perspective view of a wrench of a first embodiment according to the preferred teachings of the present invention.

FIG. 2 shows an exploded perspective view of the wrench of FIG. 1.

FIG. 3 shows a side elevational view of the wrench of FIG. 1.

FIG. 4 shows a sectional view of the wrench of FIG. 1 according to section line 4-4 of FIG. 1 with a switch of the wrench in a position allowing clockwise driving rotation and counterclockwise free rotation.

FIG. 5 shows a perspective view of the wrench of FIG. 1 according to section line 4-4 of FIG. 1 with the switch in a transition position.

FIG. 6 shows a perspective view of the wrench of FIG. 1 according to section line 4-4 of FIG. I with the switch in a position allowing counterclockwise driving rotation and clockwise free rotation.

FIG. 7 shows a sectional view of the wrench of FIG. 1 according to section line 7-7 of FIG. 1.

FIG. 8 shows a sectional view of a wrench of a second embodiment according to the preferred teachings of the present invention.

FIG. 9 shows a sectional view of a wrench of a third embodiment according to the preferred teachings of the present invention.

FIG. 10 shows a perspective view of a wrench of a fourth embodiment according to the preferred teachings of the present invention.

FIG. 11 shows an exploded perspective view of the wrench of FIG. 10.

FIG. 12 shows a perspective view of a wrench of a fifth embodiment according to the preferred teachings of the present invention.

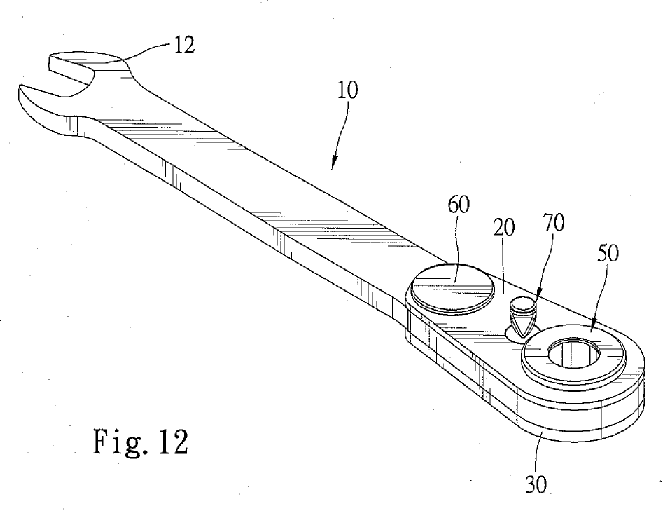

All figures are drawn for ease of explanation of the basic teachings of the present invention only; the extensions of the Figures with respect to number, position, relationship, and dimensions of the parts to form the preferred embodiment will be explained or will be within the skill of the art after the following teachings of the present invention have been read and understood. Further, the exact dimensions and dimensional proportions to conform to specific force, weight, strength, and similar requirements will likewise be within the skill of the art after the following teachings of the present invention have been read and understood.

Where used in the various figures of the drawings, the same numerals designate the same or similar parts. Furthermore, when the terms “first”, “second”, “third”, “end”, “portion”, “section”, “longitudinal”, “radial”, “annular”, “inward”, “clockwise”, “counterclockwise”, “length”, “thickness”, and similar terms are used herein, it should be understood that these terms have reference only to the structure shown in the drawings as it would appear to a person viewing the drawings and are utilized only to facilitate describing the invention.

### DETAILED DESCRIPTION OF THE INVENTION

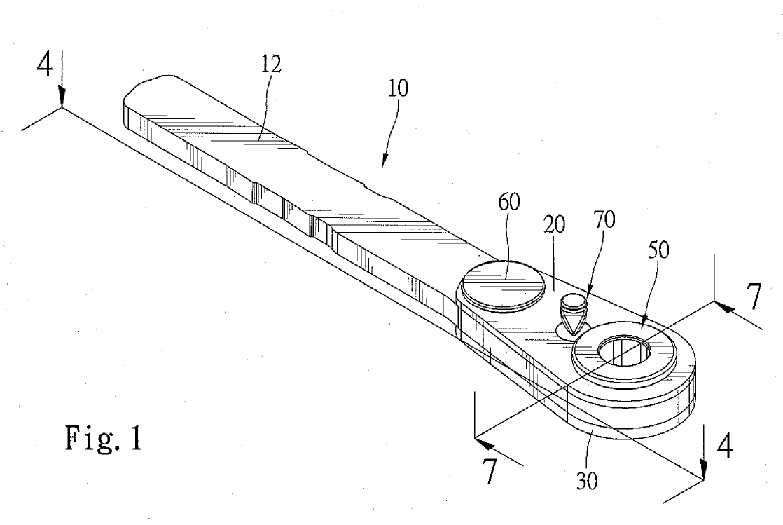

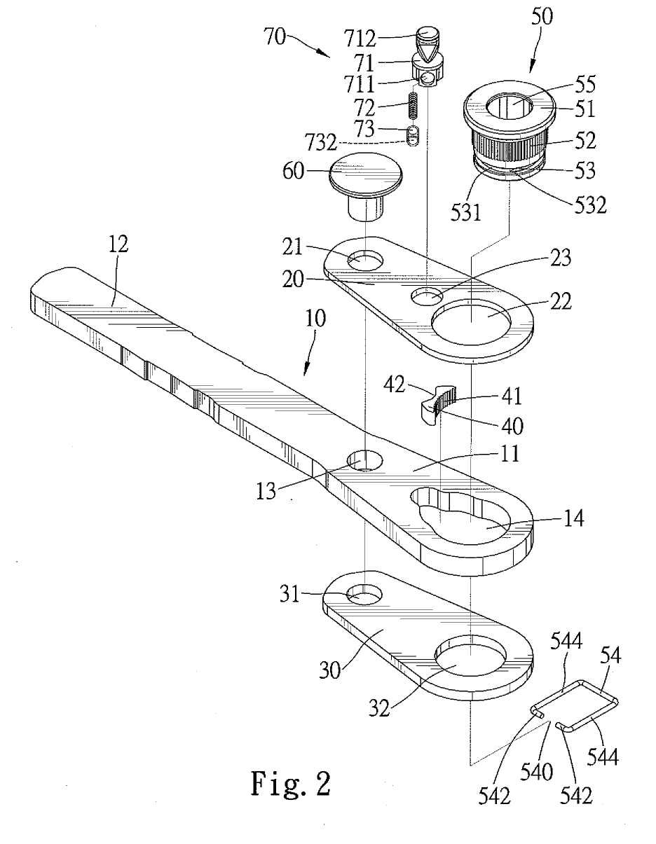

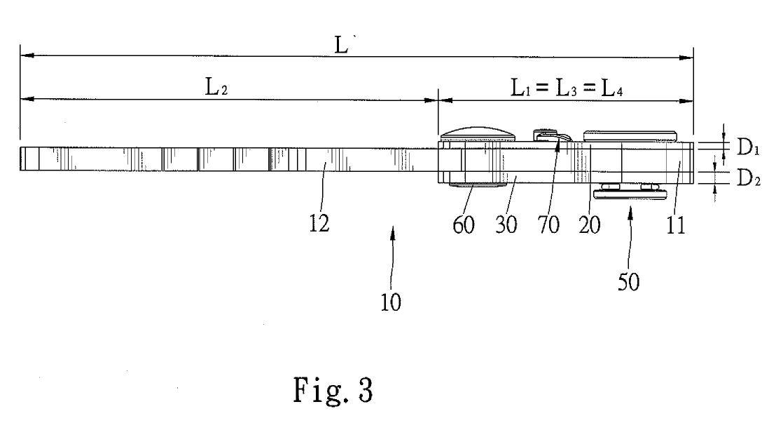

A wrench of a first embodiment according to the preferred teachings of the present invention is shown in FIGS. 1-7 of the drawings. The wrench includes a body 10 and first and second plates 20 and 30 respectively mounted on two opposite sides of the body 10. According to the preferred form, the body 10 is a thin steel plate and includes a first section 11 having a length L1 and a second section 12 having a length L2 larger than that L1 of the first section L1. The first section 11 includes increasing width away from the second section 12 to form a head of the wrench. The first section 11 includes a fixing hole 13 adjacent to the second section 12 and a compartment 14 distant to the second section 12. The compartment 14 and the fixing hole 13 extend from one of trio opposite sides through the other side of the first section 11. The second section 12 forms a gripping portion for a user and has a substantially uniform width. The overall length L of the body 10 is equal to the sum of the lengths L1 and L2 of the first and second sections 11 and 12.

According to the preferred form shown, each of the first and second plates 20 and 30 is a steel plate and has a cross sectional outline substantially the same as that of the first section 11 of the body 10. Specifically, the first plate 20 has a length L3 the same as that L1 of the first section 11 Of the body 10. Also, the second plate 30 has a length t4 the same as that L1 of the first section 11 of the body 10. The first plate 20 has a thickness D1 smaller than that D2 of the second plate 20. Furthermore, the first plate 20 includes a fixing hole 21, a mounting hole 22 spaced from the fixing hole 21, and a switch hole 23. The second plate 30 includes a fixing hole 31 and a mounting hole 32 spaced from the fixing hole 31. The first and second plates 20 and 30 are respectively mounted to opposite sides of the first section 11, with the fixing holes 21 and 31 of the first and second plates 20 and 30 aligning with the fixing hole 13 of the first section 11 of the body 10, with the mounting holes 22 and 32 of the first and second plates 20 and 30 aligning with the compartment 14 of the first section 11 of the body 10, and with the switch hole 23 of the first plate 20 aligning with a portion of the compartment 14 of the body 10. A fastener 60 is extended through the fixing holes 21, 13, and 31 to fix the body 10 and the first and second plates 20 and 30 together. In the preferred form shown, the fastener 60 is a rivet. Nevertheless, other arrangements for fixing the body 10 and the first and second plates 20 and 30 together would be within the skill of the art.

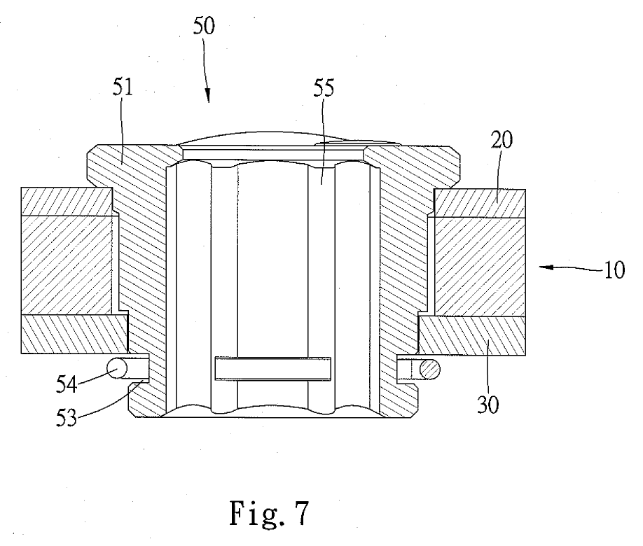

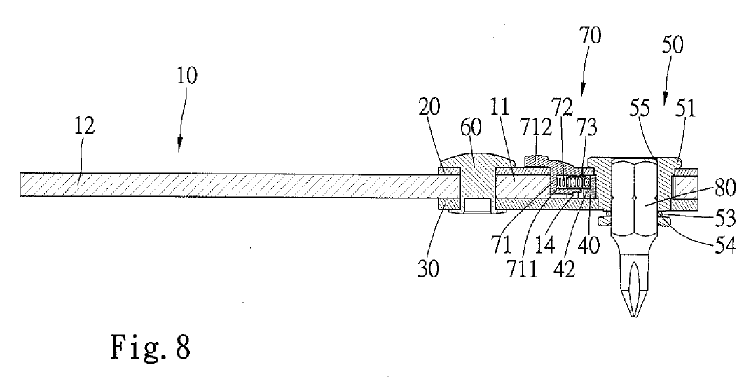

A drive member 50 is extended through the mounting holes 22 and 32 of the first and second plates 20 and 30 and the compartment 14 of the body 10 between the mounting holes 22 and 32. According to the preferred form shown, the drive member 50 is in the form of a gear ring and includes first and second ends and an annular toothed portion 52 between the first and second ends. A flange 51 is formed on the first end of the drive member 50 and a coupling portion 53 is formed on the second end of the drive member 50. The coupling portion 53 includes a pair of diametrically opposed arc groove sections 531 and a pair of diametrically opposed rectilinear groove sections 532 respectively between and deeper than the arc groove sections 53 l. The drive member 50 further includes a polygonal longitudinal through-hole 55 extending from the first end through the second end thereof. In the preferred form shown, the longitudinal through-hole 55 is hexagonal. The rectilinear groove sections 532 extend radially inward and are partially in communication with the longitudinal through-hole 55. The drive member 50 is rotatably extended in sequence through the mounting hole 22 of the first plate 20, the compartment 14 of the body 10, and the mounting hole 32 of the second plate 30, with the first plate 20 sandwiched between the flange 51 of the drive member 50 and the first section 11 of the body 10, and with the second end of the drive member 50 extending beyond the second plate 30. A retainer 54 is mounted to the second end of the drive member 50 to fix the drive member 50 in place while allowing rotational movement of the drive member 50 relative to the first and second plates 20 and 30 and the body 10. According to the preferred form, the retainer 54 is substantially a U-shaped resilient member having an opening 540 between two distal ends 542 thereof Two limbs 544 of the retainer 54 are engaged in the rectilinear groove sections 532 of the drive member 50. The limbs 544 of the retainer 54 are expanded away from each other to engage with the rectilinear groove sections 542 of the drive member 50 and then released to clamp on the second end of the drive member 50, avoiding disengagement of the drive member 50. Specifically, since the rectilinear groove sections 532 of the drive member 50 are partially aligned with the longitudinal through-hole 55, portions of the limbs 544 of the retainer 50 are located in the through-hole 55 of the drive member 50 (see FIG. 7). The limbs 544 of the retainer 50 are, thus, capable of clamping a bit 80 (see FIG. 8) received in the longitudinal through-hole 55 of the drive member 50 for driving a screw or the like. Nevertheless, the hexagonal longitudinal through-hole 55 of the drive member 50 can be coupled with a fastener including but not limited to a bolt, a nut, etc.

A pawl 40 is slideably mounted in the compartment 14 in a position outside the drive member 50. The pawl 40 includes a toothed section 41 on a face thereof for releasably coupling with the annular toothed section 52 of the drive member 50. The pawl 40 further includes a recessed portion 42 on another face thereof opposite to the face on which the toothed section 41 is formed.

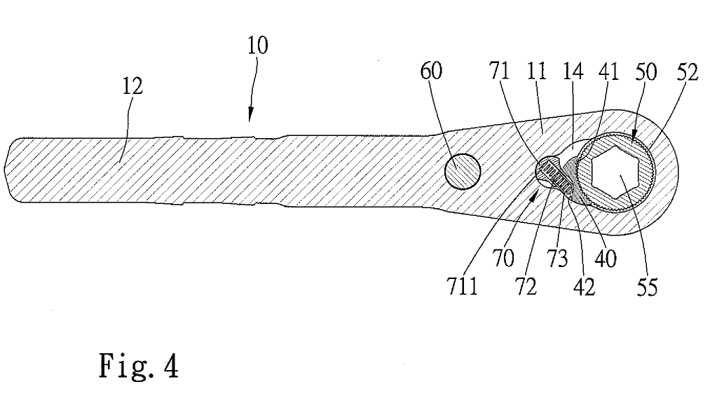

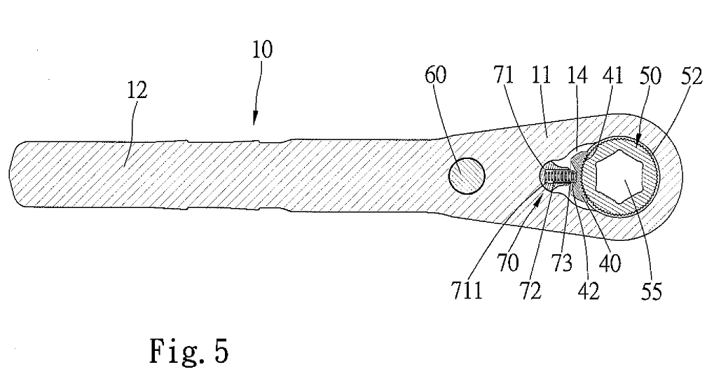

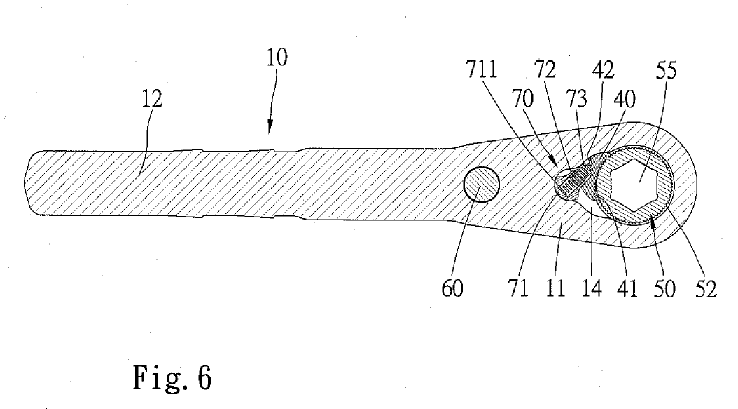

A switch 70 includes a switch body 71 rotatably received in the switch hole 23 and the compartment 14 of the body 10. The switch body 71 includes a hole 711 for slideably receiving an end of a pressing member 73 the other end of which is engaged with the recessed portion 42. According to the preferred form shown, the pressing member 73 includes a receptacle 732 facing the hole 711 of the switch body 71. An elastic element 72 is received in the hole 711 of the switch body 71 and the receptacle 732 of the pressing member 73 for biasing the other end of the pressing member 73 to press against the recessed portion 42 of the pawl 40, thereby biasing the toothed section 41 of the pawl 40 to engage with the annular tooted section 52 of the drive member 50. The switch 70 further includes an operative portion 712 extending from the switch body 71 beyond the first plate 20 for manual rotational operation. When the switch 70 is in a position shown in FIG. 4, the wrench can be turned in a clockwise direction for driving a fastener directly or indirectly coupled with the wrench. If a counterclockwise force is applied to the wrench of FIG. 4, the wrench turns freely without driving the fastener. FIG. 5 shows a transition position of the switch 70. When the switch 70 is in a position shown in FIG. 6, the wrench can be turned in a counterclockwise direction for driving a fastener directly or indirectly coupled with the wrench. If a clockwise force is applied to the wrench of FIG. 6, the wrench turns freely without driving the fastener. It can be appreciated that other direction-switching arrangements can be utilized.

To provide a longer gripping portion, the overall length L of the body 10 is greater than two times of the length L1 of the first section (L>2L1). A longer second section 12 allows the user to change the gripping locations according to needs. Specifically, the user can grip a distal end of the second section 12 to get a longer arm of force if a larger torque is required. A force-saving effect is, thus, obtained. On the other hand, the user can grip the second section 12 at a location adjacent to the first section 11 for rapidly moving the wrench.

The body 10 and the first and second plates 20 and 30 are made by punching steel blanks with a precision die without generation of burrs. Thus, troublesome processing is not required, for the body 10 and the first and second plates 20 and 30 thus formed have the required outlines. Rapid production is allowed at low costs, for steel blanks can be obtained easily. Thus, the wrench according to the preferred teachings of the present invention can be produced at low costs without adversely affecting structural strength and torque-bearing capacity and is, thus, suitable for not only professional users but also general users including DIY users. As mentioned above, the thickness D1 of the first plate 20 sandwiched between the flange 51 of the drive member 50 and the first section 11 of the body 10 is smaller than that D2 of the second plate 30. Thus, the costs are further cut by utilizing thinner first plate 20.

It is noted that the first and second plates 20 and 30 and the drive member 50 seal the compartment 14 and, thus, prevent dust from entering the compartment 14.

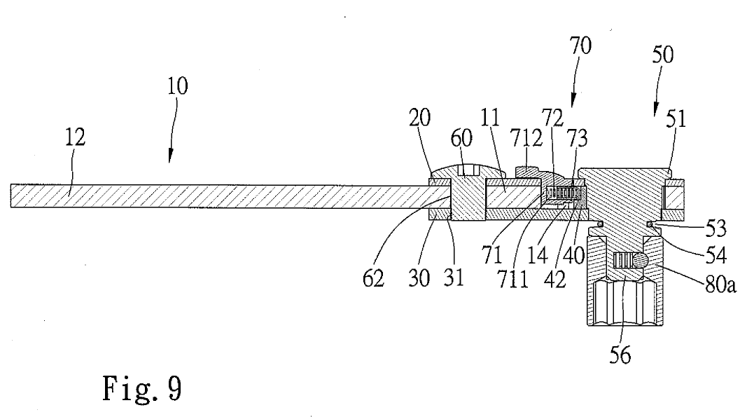

The drive member 50 may be of any other suitable forms. As an example, the drive member 50 may be in a form having a drive column 56 for releasably coupling with a socket 80a, as illustrated in FIG. 9. Furthermore, the fixing hole 31 of the second plate 30 may be a screw hole, and the fastener 60 may be a bolt having an outer Threading 62 for threadedly engaging with the screw hole 31 (FIG. 9).

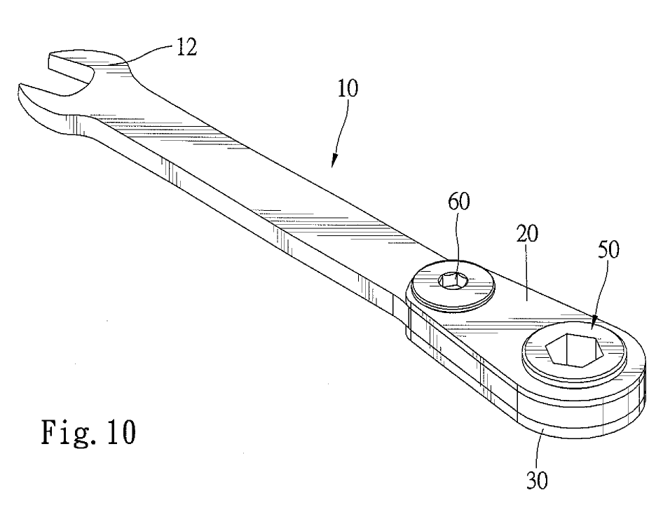

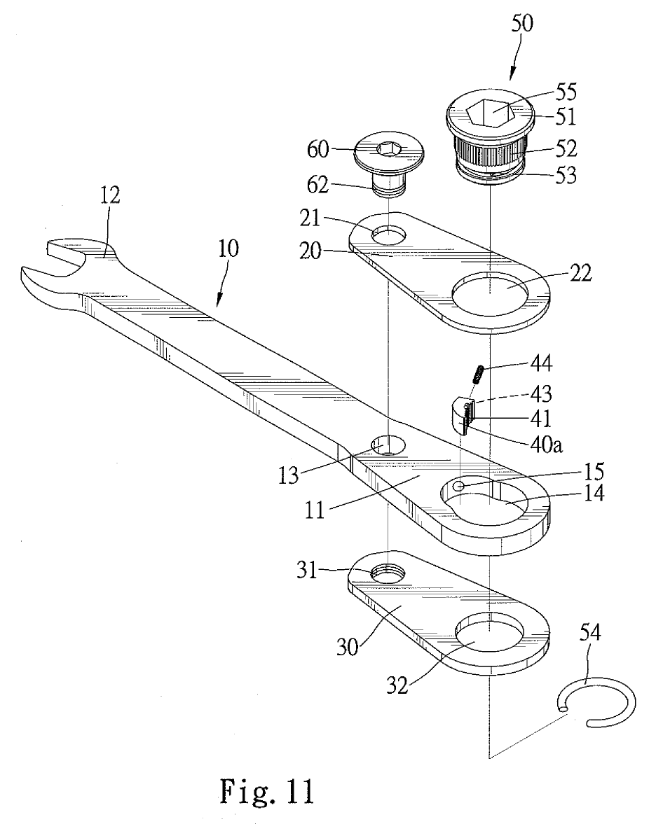

FIGS. 10 and 11 illustrate another embodiment of the wrench according to the preferred teachings of the present invention modified from the first embodiment of FIGS. 1-7, and only the differences therebetween are described to avoid redundancy. The distal end of the second section 12 includes an-opening to serve as an open-end wrench. The fixing hole 31 of the second plate 30 is a screw hole, and the fastener 60 includes outer threading 62 for threadedly engaging with the screw hole 31. The retainer 54 is substantially C-shaped. Furthermore, the pawl 40, the switch member 70, and the pressing member 73 -in the first embodiment are omitted. In this embodiment, a receptacle 15 is defined in an inner periphery defining the compartment 14 for receiving an elastic element 44. A pawl 40a is slideably received in the compartment 14 in a position outside the drive member 50 and includes a toothed section 41 releasably engaged with the annular toothed section 52 of the drive member 50. The pawl 40a further includes a protrusion 43 on a side thereof to which an end of the elastic element 44 is attached. The elastic element 44 biases the toothed section 41 of the pawl 40a to engage with the annular tooted section 52 of the drive member 50. Thus, the wrench of FIGS. 10 and 11 can be turned in a direction for driving a fastener directly or indirectly coupled with the wrench. If a force is applied to the wrench of FIGS. 10 and 11 in a reverse direction, the wrench turns freely without driving the fastener. It can be appreciated that other arrangements not allowing a change in the fastener-driving direction of the wrench can be utilized.

The body 10 and the first and second plates 20 and 30 of the wrench according to the preferred teachings of the present invention are formed by punching inexpensive steel blanks with or without subsequent simple processing. The processing costs and material costs are all cut. Furthermore, assembly of the wrench can easily be attained by a fastener 60 and a retainer 54. Further, the overall length L of the body 10 is greater than two times of the length L3, L4 of the first and second plates 20 and 30 to provide options for the user in the gripping positions of the wrench according to operational needs. Further, the thickness D1 of the first plate 20 is smaller than that D2 of the second plate 30 to further cut the costs. Thus, the wrench according to the preferred teachings of the present invention is suitable for not only professional users but also general users including DIY users.

Thus since the invention disclosed herein may be embodied in other specific forms without departing from the spirit or general characteristics thereof, some of which forms have been indicated, the embodiments described herein are to be considered in all respects illustrative and not restrictive. The scope of the invention is to be indicated by the appended claims, rather than by the foregoing description and all changes which come within the meaning and range of equivalency of the claims are intended to be embraced therein.

1. A wrench comprising:
a steel body including a first section having two opposite sides and a second section longer than the first section, with the first section including a first fixing hole and a compartment, with the compartment and the fixing hole extending from one of the sides through the other side of the first section, with the second section being adapted to be gripped by a user;
a first plate mounted to one of the sides of the first section of the body, with the first plate including a second fixing hole aligned with the first fixing hole, and with the first plate further including a first mounting hole aligned with the compartment;
a second plate mounted to the other side of the first section of the body, with the second plate including a third fixing hole aligned with the first and second fixing holes, with the second plate further including a second mounting hole aligned with the first mounting hole and the compartment;
a drive member including first and second ends and an annular toothed portion between the first and second ends, with the first end of the drive member including a flange, with the second end of the drive member including a coupling portion, with the annular toothed portion being rotatably received in the first and second mounting holes and the compartment, with the first and second ends of the drive member respectively extending beyond the first and second plates, with the first plate being sandwiched between the flange of the drive member and the first section of the body, with a retainer being coupled with the coupling portion of the drive member to rotatably retain the drive member in place and to secure the first and second plates and the body together;
a pawl slideably received in the compartment and including a toothed section;
an elastic element for biasing the toothed section of the pawl to engage with the annular toothed portion of the drive member; and
a fastener extending through the first, second, and third fixing holes to secure the first and second plates and the body together.

2. The wrench as claimed in claim 1, with the fastener being a bolt having an outer threading, and with the third fixing hole of the second plate being a screw hole threadedly engaged with the outer threading of the bolt.

3. The wrench as claimed in claim 1, with the drive member including a longitudinal through-hole extending from the first end through the second end of the drive member, with the longitudinal through-hole being adapted for coupling with a fastener to be driven by the wrench, with the coupling portion including two rectilinear groove sections extending radially inward and partially in communication with the longitudinal through-hole of the drive member, with the retainer including two sections respectively engaged in the rectilinear groove sections and extending into the longitudinal through-hole of the drive member to retain the body in place, and with the sections of the retainer being adapted for clamping a screwdriver bit received in the longitudinal through-hole of the drive member.

4. The wrench as claimed in claim 1, with the first section of the body further including a receptacle defined in an inner periphery defining the compartment for receiving the elastic element, and with the pawl including a protrusion on a side thereof to which an end of the elastic element is attached.

5. The wrench as claimed in claim 1, with the pawl including a recessed portion opposite to the toothed section of the pawl, with the first plate further including a switch hole between the second fixing hole and the first mounting hole, with the wrench further comprising, in combination: a switch including a switch body rotatably received in the switch hole of the first plate and the compartment of the body, with the switch body having a hole for receiving an end of the elastic element, with the switch further including an operative portion extending from the switch body beyond the first plate for manual operation; and a pressing member including a first end slideably received in the hole of the switch body and a second end, with the pressing member including a receptacle for receiving another end of the elastic element, and with the second end of the pressing member being biased by the elastic element to engage with the recessed portion of the pawl.

6. The wrench as claimed in claim 1, with the first and second plates having identical length the same as that of the first section of the body.

7. The wrench as claimed in claim 1, with an overall length of the body being greater than two times of a length of the first section of the body.

8. The wrench as claimed in claim 1, with the first plate having a thickness smaller than that of the second plate.

9. The wrench as claimed in claim 1, with the drive member being adapted for coupling with a socket or a screwdriver bit.
